(19) United States
(12) Patent Application Publication
(10) Pub. No.: US 2019/0114911 A1
(43) Pub. Date: Apr. 18, 2019

(54) METHOD AND SYSTEM FOR DETERMINING THE LOCATION OF A VEHICLE

(71) Applicant: Valeo North America, Inc., Troy, MI (US)

(72) Inventors: Shahram Rezaei, Troy, MI (US); David Saul Hermina Martinez, Troy, MI (US)

(73) Assignee: Valeo North America, Inc., Troy, MI (US)

(21) Appl. No.: 15/782,130

(22) Filed: Oct. 12, 2017

(51) Int. Cl. G08G 1/0967; G08G 1/16; G01C 21/26

(52) U.S. Cl. CPC G08G 1/096708; G08G 1/096783; G05D 2201/0213; G01C 21/26; B60W 2550/402; G08G 1/164

(57) ABSTRACT

A method for determining a location of a vehicle. The method includes obtaining, by a marker reader of the vehicle, a marker location from a signal emitted by a marker located in a vicinity of the vehicle. The marker location is provided relative to a known reference point. The method further includes obtaining vehicle location information relative to the first marker using at least one sensor disposed in the vehicle, and obtaining an estimate of the vehicle location relative to the known reference point, using the marker location and the vehicle location information.

### BACKGROUND

Vehicles are increasingly equipped with navigation systems that rely on knowledge about a vehicle's location in order to provide navigation services to the driver. Further, newer and future generations of vehicles include various levels of autonomous driving capabilities that depend on accurate vehicle location information. While global navigation satellite system (GNSS) services may frequently be used to determine a vehicle's location, there are various situations in which alternative methods and systems for determining a vehicles location are preferable or necessary, for example, when GNSS signals are not available or weak, or when higher accuracy than GNSS position determination is needed.

### SUMMARY

In general, in one aspect, the invention relates to a method for determining a location of a vehicle. The method includes obtaining, by a marker reader of the vehicle, a first marker location from a signal emitted by a first marker located in a vicinity of the vehicle, wherein the first marker location is provided relative to a known reference point; obtaining a first vehicle location information relative to the first marker using at least one sensor disposed in the vehicle; and obtaining an estimate of the vehicle location relative to the known reference point, using the first marker location and the first vehicle location information.

In general, in one aspect, the invention relates to a system for determining a location of a vehicle. The system includes a marker reader installed in the vehicle and configured to obtain a first marker location from a signal emitted by a first marker that is placed in a vicinity of the vehicle, wherein the first marker location is provided relative to a known reference point; at least one vehicle sensor configured to obtain a first vehicle location information relative to the first marker; and a vehicle location estimator, configured to obtain an estimate of the vehicle location relative to the known reference point, using the first marker location and the first vehicle location information.

In general, in one aspect, the invention relates to a non-transitory computer-readable storage medium storing a program, which when executed on a processor, performs instructions comprising: obtaining, by a marker reader of the vehicle, a first marker location from a signal emitted by a first marker located in a vicinity of the vehicle, wherein the first marker location is provided relative to a known reference point; obtaining a first vehicle location information relative to the first marker using at least one vehicle sensor disposed in the vehicle; and obtaining an estimate of the vehicle location relative to the known reference point, using the first marker location and the first vehicle location information.

### BRIEF DESCRIPTION OF DRAWINGS

FIGS. 1A-1C show systems for determining a vehicle's location, in accordance with one or more embodiments of the invention.

FIG. 2 shows a marker used for determining a vehicle's location, in accordance with one or more embodiments of the invention.

FIGS. 3-5 show flowcharts illustrating methods for determining a vehicle's location, in accordance with one or more embodiments of the invention.

### DETAILED DESCRIPTION

Specific embodiments of the invention will now be described in detail with reference to the accompanying figures. Like elements in the various figures are denoted by like reference numerals for consistency. Like elements may not be labeled in all figures for the sake of simplicity.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

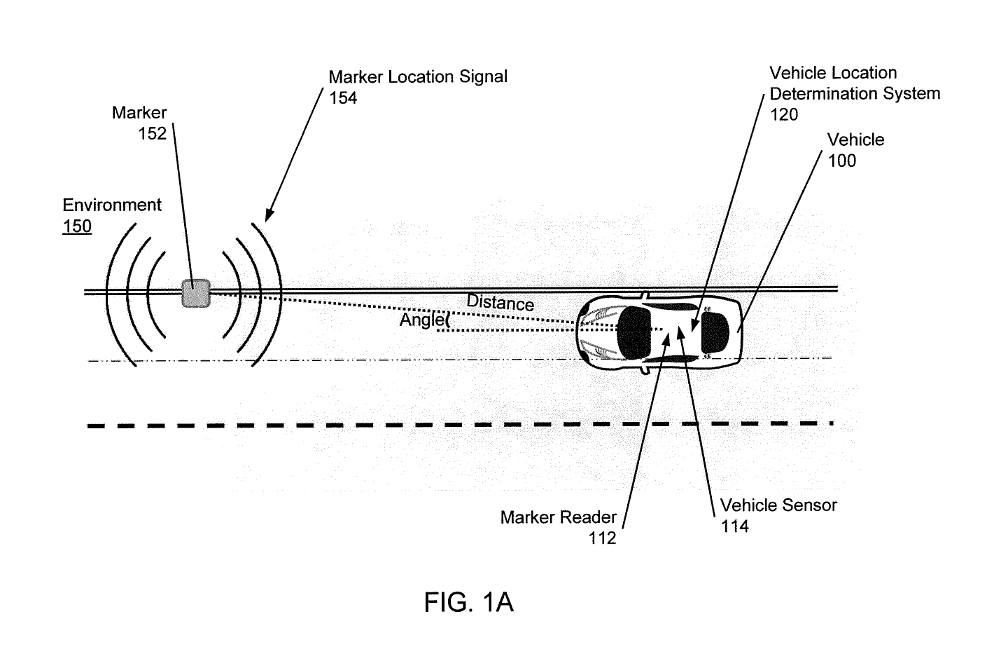

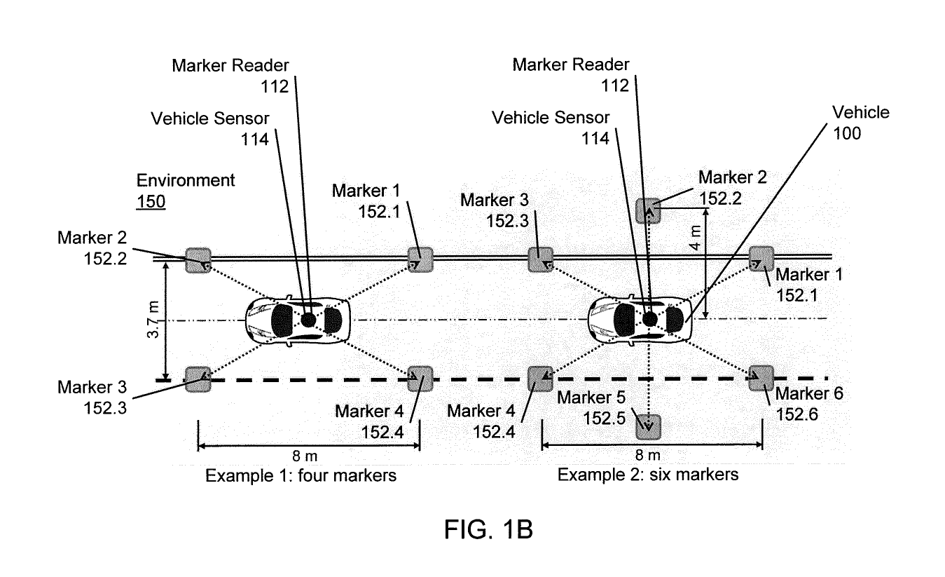

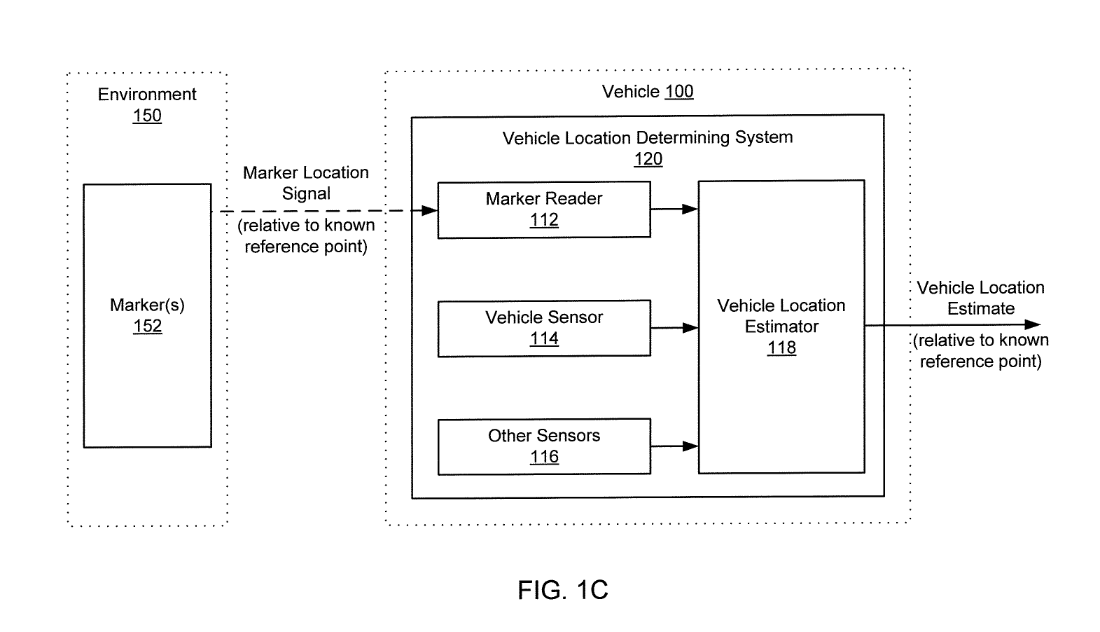

In the following description of FIGS. 1A-5, any component described with regard to a figure, in various embodiments of the technology, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the technology, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that, one or more of the steps shown in the flowcharts may be omitted, repeated, and/or performed in a different order than the order shown. Accordingly, the scope of the invention should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

While global navigation satellite system (GNSS) services such as the global positioning system (GPS) may frequently be used to determine a vehicle's location, there are various situations in which alternative methods and systems for determining a vehicles location are preferable or necessary, for example, when GNSS signals are not available. This may apply in particular in parking structures, tunnels, in the vicinity of tall buildings, etc. Frequently, vehicle navigation systems, therefore, rely on GPS-based location determination systems, supplemented by inertial measurement units (IMUs). An IMU may use inertial sensors such as gyroscopes and acceleration sensors, velocity sensors, steering angle sensors, etc. to estimate or predict the location of a vehicle, even in absence of GPS signals. If these location estimates are updated as the vehicle moves, location estimates are continuously available, over time. However, due to various inaccuracies, e.g., measurement and modeling errors, such an estimated vehicle location may have limited accuracy. While the accuracy may be high initially, e.g., immediately after GPS signals have been lost, the accuracy may deteriorate over time and may, thus, become sufficiently inaccurate to prevent use of the location estimate for the purpose of navigation and/or autonomous driving. Accordingly, such estimates may require periodic correction, using actual location information. In situations in which GPS signals are not available or when their accuracy is degraded, alternative location signal sources, different from the IMU, may, thus, be relied upon in order to accurately determine vehicle location, in accordance with one or more embodiments of the invention.

Turning to FIGS. 1A-1C, systems for determining a vehicle's location (120), in accordance with one or more embodiments of the invention, are shown. The obtained vehicle location may be the position of the vehicle, but it may further include vehicle speed and/or vehicle heading.

FIG. 1A shows an exemplary scenario in which a vehicle location is determined. The location of a vehicle (100) in an environment (150) is determined using a marker (152). Embodiments of the invention may be used in conjunction with any type of vehicle, e.g., in cars, buses, trucks, motorcycles, etc., and the environment in which the vehicle is operating may be any type of environment. For example, the environment (150) may be, a road, a tunnel or a parking structure, if the vehicle (100) is a car, a bus, a truck, or a motorcycle. Alternatively, if the vehicle (100) is, for example, a forklift, the environment (150) may be a warehouse. The marker (152) may be placed, for example, on a wall, on the ground, on the ceiling (e.g. inside a covered structure), on a pole, on a traffic light, on a traffic sign, or anywhere else, in the environment (150), in regions where the location of the vehicle (100) is to be determined using the marker (152).

In one or more embodiments of the invention, the vehicle location detection system (120) relies on a marker reader (112) and a vehicle sensor (114) to identify the location of the vehicle, using the marker (152), as subsequently described.

In one or more embodiments of the invention, the marker (152) emits a marker location signal (154) that identifies the exact location of the marker (152). Any type of coordinate system, such as a geographic coordinate system that enables the location of the marker (152) on earth to be specified using a set of numbers, letters and/or symbols, may be used to describe the absolute marker location, e.g., in a global reference frame. The location of the marker may alternatively be provided in relative coordinates, e.g., relative to a geographic landmark, an entrance of a building, another marker, etc. In one or more embodiments of the invention, the marker location signal (154) accurately provides the marker location, with a tolerance of for example, a few decimeters or a few centimeters. The marker location information may have been programmed into the marker, prior to, during, or after the installation of the marker.

In one or more embodiments of the invention, the marker location signal (154) is emitted using a radio frequency (RF) signal. The RF signal may be a Bluetooth, Bluetooth Low Energy (BLE), Wi-Fi or any other type of RF signal suitable for transmitting the marker location. The marker may operate as a beacon, capable of only transmitting but not receiving, or it may have transmitting and receiving capabilities. The emitted marker location signal (154) may be picked up by the marker reader (112) of the vehicle (100), when in the vicinity of the marker (152). Depending on the type of RF signal that is used for the emission of the marker location, the range in which the marker location signal (154) can be received by the marker reader (112) may be limited. For example, the range may be limited to 10 m or 100 m away from the marker. Those skilled in the art will appreciate that the range of the RF signal may be limited to any range, and may further be influenced by other factors such as marker location, environmental conditions, the types of antennas and signal conditioning being used, etc., without departing from the invention.

In one or more embodiments of the invention, the marker reader (112) in the vehicle (100) is configured to receive the marker location signal(s) (154) of one or more markers in the vicinity of the vehicle (100), and to forward the marker location(s) extracted from the marker location signal(s) to a vehicle location estimator (118), further described below. Depending on the type of RF signal that is used by the marker(s) (152), the marker reader (112) includes the proper RF signal receiver, such as a BLE or Wi-Fi receiver.

In one or more embodiments of the invention, the vehicle (100) is further equipped with a vehicle sensor (114). A detection of the marker location(s), in accordance with one or more embodiments of the invention, performed by the vehicle sensor (114), is relative to the vehicle (100). The marker location information, obtained by performing the detection, may include a distance of the marker(s) from the vehicle and/or one or more marker angles. Depending on the data included in the marker location information, a unique point in space may be identified as the location of a marker (e.g., when marker distance and marker angles are included in the marker location information), or a direction of the marker in space may be identified (e.g., when only marker angles are obtained), or a radius of a circle or sphere on which the marker may be located may be identified (e.g., when only the marker distance is obtained). In one or more embodiments of the invention, the marker location information is provided to the vehicle location estimator (118), where it is used to estimate the vehicle's location, as further described below.

In one or more embodiments of the invention, the marker detection is performed using optical sensing. The optical sensing is performed by a vehicle sensor (114) that may be a light detection and ranging (LiDAR) sensor, a stereoscopic camera or a non-stereoscopic camera. While LiDAR sensors and stereoscopic cameras may provide angle and distance information, non-stereoscopic monochrome or color cameras may provide angle information. Additionally or alternatively, non-optical sensing techniques may be employed. For example, the RF signal emitted by the marker (152) may be suitable to determine distance using a time of flight (ToF) identification. Further, a relative received signal strength (RSSI) may be used to determine the distance of the marker. In one or more embodiments of the invention, multiple vehicle sensors (114) may be installed in the vehicle (100). For example, the vehicle (100) may include multiple cameras that are oriented differently to cover a wide range of angles. Any combination of sensors may be used as the vehicle sensor (114). For example, combinations of a LiDAR sensor and one or more optical cameras may be used. Further a radar sensor may be used alone or in combination with other sensors to obtain marker distance and/or marker angle. Functionally, some sensors may be used merely to detect the presence of a marker, other sensors may be used to obtain a marker distance, and other sensors may further be used to obtain a marker angle. Alternatively, sensors that perform a combination of these functions may be used.

The type of sensing performed by the vehicle sensor (114) may determine possible marker placement locations and/or the appearance of the marker(s) (152). If the vehicle sensor (114) is an optical sensor, direct line-of-sight may be needed between the vehicle sensor (114) and the marker(s) (152). Further, depending on the detection method being used (e.g., if image processing is used on one or more video frames obtained by a camera), the marker (152) may be required to have certain visual characteristics. These visual characteristics may include, but are not limited to, a particular geometry, color and/or pattern, etc. In contrast, if non-optical sensing methods are used, direct line-of-sight contact may not be necessary. For example, if the marker location sensing is based on ToF or RSSI methods, the marker(s) (152) may not need to be visible. This may allow the marker(s) (152) to be embedded in other structures such as in a floor, wall or ceiling, without preventing the obtaining marker location information by the vehicle sensor (114).

Using the marker location obtained by the marker location signal (154), by the marker reader (112), and the marker location relative to the vehicle, obtained by the vehicle sensor (114), the location of the vehicle (100) may be estimated by the vehicle location estimator (118), as further described below.

Turning to FIG. 1B, exemplary scenarios in which a vehicle location is determined using four and six markers, respectively, are shown. In one or more embodiments of the invention, the use of multiple markers may be beneficial for obtaining a more accurate estimate of the vehicle location. The data from multiple markers may be combined to obtain a higher-accuracy estimate, as further described below. As shown in FIG. 1B, more than one marker may be used to obtain a vehicle location estimate, in accordance with one or more embodiments of the invention. The markers may be placed in different geometrical configurations. By spreading out markers in the environment, a vehicle may be able to receive signals from one or more markers, which may result in an increased estimation accuracy and/or robustness. One measure for determining the accuracy of a location estimator is the dilution of precision (DOP). A lower DOP indicates a higher accuracy. In the examples of FIG. 1B, increasing the number of markers from four to six may result in a DOP that is lowered by approximately 50%, resulting in a corresponding improvement of the accuracy of the vehicle location estimate.

In one or more embodiments of the invention, the use of multiple markers (152) for determining the location of the vehicle may also provide redundancy. Assume, for example, that in example 1 of FIG. 1B, the marker reader (112) is unable to obtain a signal from marker 1 (152.1), and in addition, the vehicle sensor (114) is unable to detect marker 1 (152.1). Further, assume that the marker reader (112) is unable to obtain a signal from marker 2 (152.2), but the vehicle sensor (114) successfully detects marker 2 (152.2). In addition, assume that the marker reader obtains a signal from marker 3 (152.3), but the vehicle sensor (114) fails to detect marker 3 (152.3). However, marker 4 (152.4) is properly detected by the vehicle sensor (114), and a marker location signal is also received from marker 4 (152.4), by the marker reader (112). In this exemplary scenario, even though markers 1-3 (152.1-152.3) cannot be used to estimate the location of the vehicle, a successful estimation can be completed using marker 4 (152.4). This redundancy may be beneficial in particular in situations where markers have the potential to be occluded, e.g., by other traffic that may prevent the vehicle sensor (114) from detecting one or more of the markers.

Those skilled in the art will recognize that the invention is not limited to the scenarios introduced in FIGS. 1A and 1B. For example, any number of markers may be employed to obtain a vehicle location estimate, the markers may be located in regions not shown in FIGS. 1A and 1B, and further additional vehicles may rely on the same markers to also obtain their vehicle location estimates.

FIG. 1C shows a schematic block diagram of the previously described vehicle location determination system (120), in accordance with one or more embodiments of the invention. As previously illustrated in the examples of FIGs. 1A and 1B, the marker reader (112) obtains one or more marker locations from the marker location signals emitted by the marker(s) (152). As an example, the marker reader (112) receives a signal including location information of the marker (152) from the marker. In addition, the vehicle sensor (114) obtains marker location information, describing the location of the marker(s) (152) relative to the vehicle. These signals and the information captured through vehicle sensors are processed by the vehicle location estimator (118) to determine a vehicle location estimate relative to a known reference point, as further described below with reference to the flowcharts. The vehicle location estimator (118) may further consider signals obtained from other sensors (116). These other sensors may include gyroscopes, velocity sensors, steering angle sensors, etc. The additional sensory data obtained from the other sensors (116) may be fused with the data obtained from the markers as described in the flowcharts.

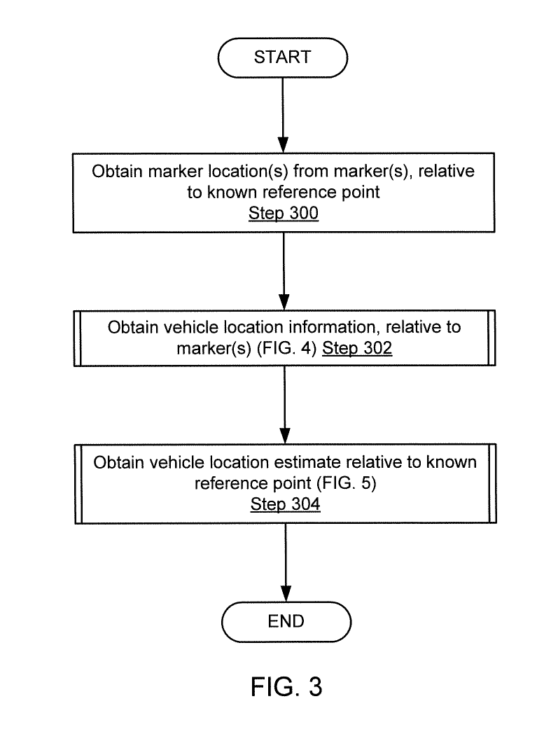

The vehicle location estimator (118) may include a computing device configured to perform one or more of the steps described below with reference to FIGS. 3-5. The computing device may be, for example, an embedded system that includes all components of the computing device on a single printed circuit board (PCB), or a system on a chip (SOC), i.e., an integrated circuit (IC) that integrates all components of the computing device into a single chip. The computing device may include one or more processor cores, associated memory (e.g., random access memory (RAM), cache memory, flash memory, etc.), a network interface (e.g., a local area network (LAN), a wide area network (WAN) such as the Internet, mobile network, or any other type of network) via a network interface connection (not shown), and interfaces to storage devices, input and output devices, analog-to-digital and digital-to-analog converters, etc. The computing device may further include one or more storage device(s) (e.g., a hard disk, an optical drive such as a compact disk (CD) drive or digital versatile disk (DVD) drive, a flash memory stick, etc.), and numerous other elements and functionalities. In one embodiment of the invention, the computing device includes an operating system that may include functionality to execute the methods further described below. Those skilled in the art will appreciate that the invention is not limited to the aforementioned configuration of the computing device.

The vehicle location estimator (118) may interface with one or more vehicle electronic control units (ECU) (not shown). The vehicle ECU is a processing unit that may support one or more of the vehicle's functionalities. The vehicle ECU may also include, for example, an input/output interface for the vehicle's instrument cluster, the vehicle's navigation system, etc. The vehicle location estimate, provided by the vehicle location estimator (118) may thus be made available to those vehicle components that require location information. This may be, for example, the vehicle's navigation system or an autonomous driving unit.

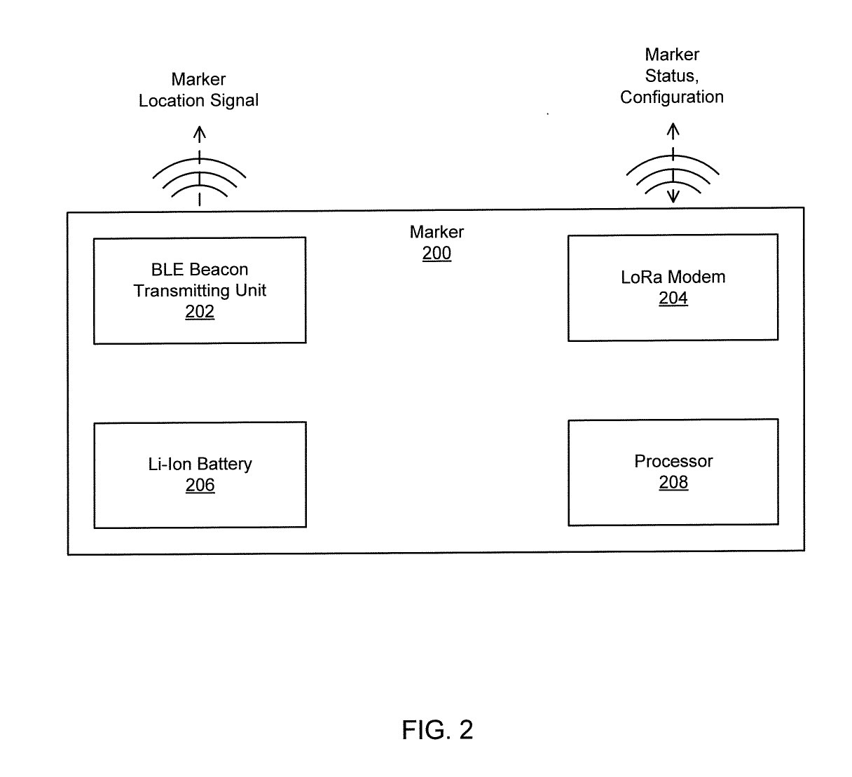

Turning to FIG. 2, a marker used for determining a vehicle's location, in accordance with one or more embodiments of the invention, is schematically shown. The marker (200) may include a Bluetooth Low Energy (BLE) beacon transmitting unit (202), a long range (LoRa) modem (204), a lithium-ion battery (206), and any other elements. In addition, the marker (200) may include one or more processors (208), memory units (not shown) and other elements, without departing from the teachings of the present disclosure.

The BLE beacon transmitting unit (202), as previously described, is configured to emit a location signal that precisely specifies the location of the marker (200). The BLE beacon transmitting unit may periodically emit the location data, and may permit one-way communication only. The communication range of the BLE beacon may be anywhere between, for example, 5 and 15 meters. The location signal may be emitted frequently enough to enable vehicles entering the communication range to receive the location signal before moving out of range when traversing the zone in which the location signal is receivable. For example, if a vehicle moves at 10 m/s, then emitting the location signal at 10 Hz may be frequent enough to allow receiving of the location signal even if the vehicle only traverses a distance of 1 m within the communication range of the BLE beacon transmitting unit.

The marker reader (112) of the vehicle (100) may, thus, merely need to listen to the location information that is advertised by the BLE beacon transmitting unit (202), thereby not requiring time and power consuming protocol negotiations and two-way communication. Because the use of the BLE protocol enables marker advertisement while using limited power only, the marker (200) may be powered by a battery, e.g., a lithium-ion battery (206). Alternative power sources may be used, without departing from the invention. For example, the marker may be equipped with other types of batteries, solar panels, etc. Further, any other wireless communication protocol may be used to transmit the marker location information, without departing from the invention. For example, Wi-Fi, Zigbee, radio frequency identification (RFID), or cellular communication protocols may be used.

In one or more embodiments of the invention, the LoRa modem (204) is used to enable communication between the marker (200) and a gateway. The range of the LoRa signal may be, for example, 100 meters. This range may be increased or decreased by adjusting transmission power. Communication with the marker may be performed to update the marker's software over the air, modify configuration parameters, activate or deactivate the marker, to obtain a health status, battery level, and/or other such information. To conserve energy, the time interval between status transmissions may be fairly long, e.g., status transmission may be performed only once per day. Communication protocols other than LoRa may be relied upon. For example, LTE-M, SigFox, or any other protocol may be used, without departing from the invention.

Turning to FIG. 3, a flowchart, in accordance with one or more embodiments of the invention, is shown. The process depicted in FIG. 3 may be used to obtain an estimate of a vehicle location, in accordance with one or more embodiments of the invention. One or more of the steps in FIG. 3 may be performed by the components of the vehicle location determining system (120), discussed above in reference to FIG. 1C.

In one or more embodiments of the invention, one or more of the steps shown in FIG. 3 may be omitted, repeated, and/or performed in a different order than the order shown in FIG. 3. Accordingly, the scope of the invention should not be considered limited to the specific arrangement of steps shown in FIG. 3.

In Step 300, the marker location relative to a known reference point is obtained from the marker. The marker location, in accordance with one or more embodiments of the invention, may be obtained from a radio transmission of the marker location, emitted by the marker. The marker location is provided in an absolute reference frame, e.g., in a globally valid geographic coordinate system or in a locally valid reference frame, e.g., relative to a landmark, a physical structure, etc. If multiple markers are in the vicinity of the vehicle, the marker locations of these multiple markers may be obtained.

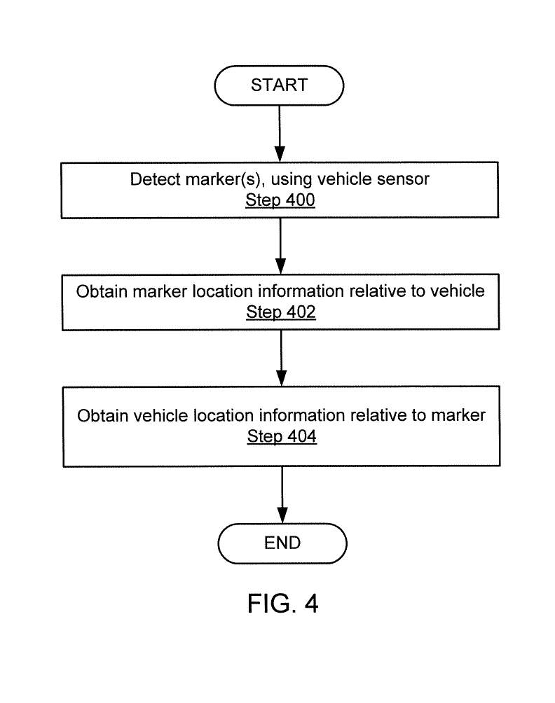

In Step 302, vehicle location information, relative to one or more markers, is obtained. The information may describe the vehicle's location relative to the marker(s) using distance between the vehicle and one or more markers, and/or one or more angles between the direction of movement of the vehicle and an imaginary line between the vehicle and the marker. The details of Step 302 are provided in FIG. 4.

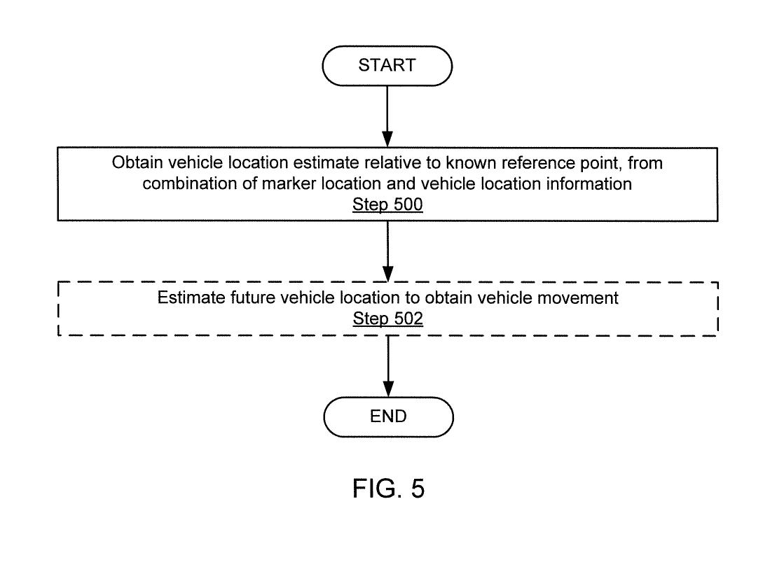

In Step 304, an estimate of the vehicle's location is determined relative to the known reference point, using the data obtained in Steps 300 and 302. The details of Step 304 are provided in FIG. 5. The estimate of the vehicle location, obtained in Step 304, in conjunction with known coordinates of elements of the environment may be used for navigation and autonomous driving purposes. For example, the availability of the vehicle's location may enable determination of the vehicle's location relative to another object such as an obstacle, a road, a lane, etc.

In one or more embodiments of the invention, one or more of the steps described in FIG. 3 are repeatedly executed. Repeated execution of these steps may enable updating of the vehicle's location, e.g., as the vehicle is moving, thereby maintaining an accurate estimate of the vehicle's location over time. As the vehicle is moving, additional markers may appear in the vicinity of the vehicle, whereas other markers may no longer be in the vicinity of the vehicle. Accordingly, the markers considered by the method described in FIG. 3 may change over time.

Turning to FIG. 4, a flowchart, in accordance with one or more embodiments of the invention, is shown. The process depicted in FIG. 4 may be used to determine a vehicle's location relative to a marker.

In Step 400, a marker is detected using a vehicle sensor. Depending on the type of the vehicle sensor and the type of marker being present in the vicinity of the vehicle, the presence of the marker may be detected optically or based on an RF signal emitted by the marker. The optical detection of the marker (e.g., using a LiDAR sensor or a camera) may be performed using three-dimensional or two-dimensional image processing methods that are capable of recognizing a particular shape, color and/or pattern that identify the marker. If the marker detection is based on RF signals, the marker may be invisible and therefore may be detected merely by the presence of the RF signal. If multiple markers are present in the vicinity of the vehicle, Step 400 may be performed for one or more markers.

In Step 402, information about the marker location relative to the vehicle is obtained. The information that describes the marker location may depend on the type of marker and the type of vehicle sensor being used for obtaining the marker location information. More specifically, if a marker is optically detected, using, for example, a LiDAR sensor or a stereoscopic camera, the marker location may be obtained relative to the vehicle in all three dimensions. In other words, the marker location information may describe a point in space that identifies the marker. One skilled in the art will appreciate that various representations may be used to identify the location of the marker. For example, x, y and z coordinates may specify the location of the marker relative to the vehicle. Alternatively, various distance/angle formats may be used to describe the marker location. Alternatively, if the marker is optically detected using a non-stereoscopic camera, one or more angles describing the marker location relative to the vehicle may be obtained. Similarly, if the marker location is obtained using the analysis of the marker's RF signal, e.g., using time-of-flight methods, a marker distance may be obtained. In general, information about location of the marker relative to the vehicle may be gathered from one or more sensors and fused together to determine the relative location of the marker with respect to the vehicle. If multiple markers are present in the vicinity of the vehicle, Step 402 may be performed for one or more markers.

In Step 404, vehicle location information is obtained relative to the marker. Step 404 may be performed in various ways, depending on the marker location information obtained in Step 402. If a complete description of the marker location relative to the vehicle was obtained in Step 404, the vehicle location relative to the marker may be directly obtained through the inverse geometric relationship. Further, if complete descriptions of marker locations relative to the vehicle were obtained for multiple markers, the obtained data may be fused to obtain a higher-accuracy vehicle location estimate. The fusion may be performed using optimization methods that minimize a location error, e.g., using a least-squares method.

In one embodiment, marker location information obtained for multiple markers may be used. As an example, if only distance information for different markers is available, at least three of these distances may be combined to obtain vehicle location information, relative to one of the markers. Error minimization methods may be used to obtain a high-accuracy vehicle location estimate. Similarly, if only angle information is available, a vehicle location estimate may also be obtained by combining angle information obtained for multiple markers.

Regardless of the type of marker location information obtained in Step 402, the use of location information of additional markers may result in a higher-accuracy estimates of the vehicle location.

Turning to FIG. 5, a flowchart, in accordance with one or more embodiments of the invention, is shown. The process depicted in FIG. 5 may be used to determine the location of the vehicle relative to a known reference point.

In Step 500, the vehicle location is obtained using the marker location relative to the known reference point obtained from the marker location signal, and the vehicle location information relative to the marker. The vehicle location may be obtained relative to the known reference point by geometrically combining the vehicle location information relative to the marker, with the marker location relative to the known reference point. Intuitively, this geometric combination may be understood as an addition of a vector that describes the vehicle location relative to the marker and a vector that describes the marker location relative to the known reference point. Although, depending on the geometric representation used to describe marker and vehicle location, these operations may be performed in different ways, the result is the estimated vehicle location relative to the known reference point, in accordance with one or more embodiments of the invention. A similar operation may be performed if multiple markers were relied upon to determine the vehicle location, relative to the markers. In such a scenario, an optimized estimated vehicle location may be obtained using least squares optimization, or any other error minimization approach.

In Step 502, a continuous estimation of the vehicle location, for example once every second, may be performed using vehicle or other sensors such as a camera, a laser scanner, etc. While the estimation is optional, it may be useful to maintain an accurate vehicle location as the vehicle is moving, in particular when the vehicle goes in and out of communication ranges of markers. Consider, for example, a scenario in which markers are spaced at far distance from each other, for example every 100 meters. In this scenario, without estimation, no location information may be available when the vehicle is in a region without any markers in the vicinity. In order to consistently obtain location information, which may be critical to perform navigation and/or autonomous driving functions, the vehicle location is estimated, even in absence of a current marker location estimate, as subsequently described.

In one embodiment of the invention, a Kalman filter may be used to recursively perform a forward prediction. The Kalman filter may include a basic model of the vehicle dynamics, enabling the forward prediction. While contact with one or more markers is available, the location information, e.g., the location estimate obtained in Step 500, may serve as an input to the Kalman filter. The Kalman filter may further obtain other inputs. Specifically, signals obtained from the vehicle's inertial measurement unit (IMU) may be considered. These signals may include gyroscope data, but also wheel sensor data such as steering angle, velocity, etc. In one or more embodiments of the invention, these signals are available even when no markers are in the vicinity of the vehicle and may thus be used to estimate vehicle location in absence of a marker-based location estimate. Once the vehicle reaches a location in which markers are, again, available, the available markers may be considered for the estimation of the vehicle location.

In one or more embodiments of the invention, IMU data and/or GPS data may be relied upon to supplement the location information obtained using the marker(s) even while the vehicle is in the vicinity of markers. This may enable further increasing location estimation accuracy in comparison to the use of marker information only. A Kalman filter or other sensor data fusion methods such as the least squares method, may be used for this data fusion.

In one or more embodiments of the invention, if multiple signals are available that are suitable to be used to estimate vehicle location, the contribution of these signals is weighted to improve estimation accuracy. A signal that is less likely to improve accuracy may be considered to a lesser degree in comparison to a signal that is more likely to improve accuracy.

Further, regardless of whether the estimation is based on marker information, IMU data and/or GPS data, the estimation may be performed for various location variables including vehicle position, vehicle speed and/or vehicle heading. Vehicle speed and heading may be obtained, using the change between vehicle location estimates obtained at different points in time, e.g., using subsequently obtained vehicle location estimates.

Various embodiments of the invention have one or more of the following advantages. A vehicle location may be determined, using methods and systems in accordance with one or more embodiments of the invention, in the absence of GPS signals. This may enable navigation and or autonomous driving features that would otherwise be unreliable or not available, e.g., in a covered parking structure. Embodiments of the invention enable estimation of a vehicle position, a vehicle speed and/or a vehicle heading. Forward prediction may further improve accuracy and/or may enable continued location estimation even when markers are temporarily not in the vicinity of the vehicle.

While the technology has been described with respect to a limited number of embodiments, those skilled in the art, having benefit of this disclosure, will appreciate that other embodiments can be devised which do not depart from the scope of the technology as disclosed herein. Accordingly, the scope of the technology should be limited only by the attached claims.

1. A method for determining a location of a vehicle, the method comprising:
obtaining, by a marker reader of the vehicle, a first marker location from a signal emitted by a first marker located in a vicinity of the vehicle,
wherein the first marker location is provided relative to a known reference point;
obtaining a first vehicle location information relative to the first marker using at least one vehicle sensor disposed in the vehicle; and
obtaining an estimate of the vehicle location relative to the known reference point, using the first marker location and the first vehicle location information.

2. The method of claim 1, further comprising:
obtaining, by the marker reader of the vehicle, a second marker location from a signal emitted by a second marker, located in the vicinity of the vehicle,
wherein the second marker location is different from the first marker location;
obtaining a second vehicle location information relative to the second marker using the at least one vehicle sensor; and
wherein obtaining the estimate of the vehicle location further comprises using the second marker location and the second vehicle location information, fused with the first marker location and the first vehicle location information.

3. The method of claim 2,
wherein the fusion of the second marker location and the second vehicle location information with the first marker location and the first vehicle location information is performed using a least squares operation.

4. The method of claim 2,
wherein the fusion of the second marker location and the second vehicle location information with the first marker location and the first vehicle location information is performed using a Kalman filter.

5. The method of claim 1, wherein the first vehicle location information comprises an angle and a distance of the first marker from the vehicle sensor.

6. The method of claim 1, wherein the first vehicle location information comprises a distance of the first marker from the vehicle sensor, and wherein at least two additional distances to two additional markers are measured to obtain the estimate of the vehicle location.

7. The method of claim 1, further comprising fusing the estimate of the vehicle location with additional vehicle location estimates obtained by the vehicle using at least one other sensor to improve accuracy of the vehicle location estimate.

8. The method of claim 7, wherein the at least one other sensor comprises a global positioning system.

9. The method of claim 1, wherein the at least one vehicle sensor comprises at least one optical sensor.

10. The method of claim 1, wherein the signal emitted by the first marker is a Bluetooth Low Energy signal.

11. A system for determining a location of a vehicle, the system comprising:
a marker reader installed in the vehicle and configured to obtain a first marker location from a signal emitted by a first marker that is placed in a vicinity of the vehicle,
wherein the first marker location is provided relative to a known reference point;
at least one vehicle sensor configured to obtain a first vehicle location information relative to the first marker; and
a vehicle location estimator, configured to obtain an estimate of the vehicle location relative to the known reference point, using the first marker location and the first vehicle location information.

12. The system of claim 11,
wherein the marker reader is further configured to obtain a second marker location from a signal emitted by a second marker, located in the vicinity of the vehicle,
wherein the second marker location is different from the first marker location;
wherein the at least one vehicle sensor is further configured to obtain a second vehicle location information relative to the second marker, and
wherein obtaining the estimate of the vehicle location, by the vehicle location estimator, further comprises using the second marker location and the second vehicle location information, fused with the first marker location and the first vehicle location information.

13. The system of claim 11, wherein the first vehicle location information comprises an angle and a distance of the first marker from the vehicle sensor.

14. The system of claim 11,
wherein the first vehicle location information comprises a distance of the first marker from the vehicle sensor, and
wherein the at least one vehicle sensor is further configured to obtain at least two additional distances to two additional markers to obtain the estimate of the vehicle location.

15. The system of claim 11, wherein the vehicle location estimator is further configured to fuse the estimate of the vehicle location with additional vehicle location estimates obtained by the vehicle using at least one other sensor to improve accuracy of the vehicle location estimate.

16. The system of claim 15, wherein the at least one other sensor comprises a global positioning system.

17. The system of claim 11, wherein the at least one vehicle sensor comprises at least one optical sensor.

18. The system of claim 11, wherein the signal emitted by the first marker is a Bluetooth Low Energy signal.

19. A non-transitory computer-readable storage medium storing a program, which when executed on a processor, performs instructions comprising:
obtaining, by a marker reader of the vehicle, a first marker location from a signal emitted by a first marker located in a vicinity of the vehicle,
wherein the first marker location is provided relative to a known reference point;
obtaining a first vehicle location information relative to the first marker using at least one vehicle sensor disposed in the vehicle; and
obtaining an estimate of the vehicle location relative to the known reference point, using the first marker location and the first vehicle location information.

20. The non-transitory computer-readable storage medium of claim 19, wherein the first vehicle location information comprises an angle and a distance of the first marker from the vehicle sensor.
